(19) United States
(12) Patent Application Publication
(10) Pub. No.: US 2026/0314607 A1
(43) Pub. Date: Oct. 15, 2026

(54) FORMULATION, ROLLED DOUGH AND METHOD FOR PRODUCING A GLUTEN-FREE BAKED FOOD PRODUCT

(71) Applicant: Dr. Schär S.P.A., Postal (IT)

(72) Inventors: Virna Lucia CERNE, Duino-Aurisina (IT); Ombretta POLENGHI, Trieste (IT); Giovanni BIASON, Pordenone (IT)

(21) Appl. No.: 19/483,130

(22) PCT Filed: May 8, 2024
(86) PCT No.: PCT/IT2024/050092

§ 371 Date: Nov. 10, 2025

(30) Foreign Application Priority Data
May 11, 2023 (IT) 102023000009411

(51) Int. Cl. A21D 13/066; A21D 2/18; A21D 2/26; A21D 13/04; A21D 13/80

(52) U.S. Cl. CPC A21D 13/066; A21D 2/186; A21D 2/262; A21D 2/263; A21D 13/04; A21D 13/80

(57) ABSTRACT

A rolled dough including a mixture of powdered or dry ingredients, a mixture of liquid ingredients and natural yeasts, a method and a plant for producing a gluten-free baked food product, in particular a naturally leavened and gluten-free food product.

### FIELD OF THE INVENTION

The embodiments described here concern a formulation, a rolled dough and a method for producing a gluten-free baked food product, in particular a naturally leavened and gluten-free food product.

### BACKGROUND OF THE INVENTION

In the field of leavened food products, “bread” type products, that is, naturally leavened using yeasts, generally brewer's yeast, have distinctive physical and organoleptic characteristics. In particular, a naturally leavened food product has a less homogeneous alveolate structure, in terms of shape and size of the cells, than that of chemically leavened products, such as sponge cake and suchlike. Typically, naturally and non-naturally leavened products are obtained from doughs based on soft wheat flour (Triticum aestivum), known to contain gluten (a protein present in cereals such as wheat, spelt, barley, rye, triticale, Kamut® and other ancient cereals precursors of wheat). Gluten is a fundamental structural component for leavened products, since it forms a viscoelastic reticular structure, called gluten mesh, capable of retaining leavening gases (Hoseney, 1994a; Hui et al. 2006), supporting the dough in the growth which is caused by the leavening itself and thus allowing the formation of the typical alveolate structure. In general, soft wheat flour provides volume and structure to most baked goods, including bread, cakes, cookies and snacks; it has the ability to form a viscoelastic dough when mixed with water at room temperature (Lawton, 1992; Hui et al., 2006). The factors that contribute to the good quality of a leavened product are related to the amino acid composition, structure and polymeric nature of the dough's proteins, particularly in relation—as mentioned—to the presence of gluten, including its main components gliadin and glutenin (Hamer and Hoseney, 1998; Atwell, 2001). More specifically, the dough needs a balance between elasticity and extensibility in order to maximize its cooking performance. Another important factor in determining the properties of the dough is the so-called “strength” of the flour, that is, its ability to absorb a large amount of water and bind carbon dioxide by having a good gluten mesh (Stringher, 2006). All these technological qualities do not belong to the other proteins of gluten-free cereals and pseudocereals, such as rice, corn, millet, buckwheat for example. As a result, the production of gluten-free leavened food products presents considerable technical difficulties, so much so that, for example, U.S. Pat. No. 4,362,751, which discloses a naturally leavened sweet bread product and a method to produce it, states that, in the absence of gluten, the typical spongy structure of conventional bread is practically impossible to achieve in a continuous process as described therein.

Document EP 0 715 811 A2 is also known, which describes a process for obtaining a mother dough for leavened sweet products with gluten.

It is also known that there is an ever-increasing demand for gluten-free food products in the market, caused by disorders such as celiac disease and gluten sensitivity. Celiac disease is one of the most well-known food-induced diseases: it is an inflammation of the small intestine triggered by the ingestion of gluten and gluten-like proteins, due to an autoimmune response to gliadin and glutenin, with consequent lesions of the intestinal mucosa and malabsorption of nutrients (Troncone et al., 2011). Celiac disease is diagnosed in 1-2% of the world's population and is estimated to be on the rise (Gujral et al., 2012).

Recent studies have shown the presence of another gliadin-related disorder: gluten sensitivity. While celiac disease manifests itself with a response to gluten by the innate and adaptive immune system, sensitivity activates only the innate system and manifests itself via inflammation of the intestinal epithelium (Robins et al., 2008).

Until now, the only treatment for the aforementioned disorders is to strictly abandon gluten-containing products for life. Therefore, in order to meet this requirement and maintain the quality of life of celiac patients, it is necessary to develop gluten-free food products.

Because gluten cannot be used in products for celiacs, starch, fibers, plant proteins, and fats become essential to improve the structure and acceptability of gluten-free products.

Starches are a primary source of energy stored in many plants (Thomas et al, 1999); in addition to their nutritional value, they are used in a variety of food products as gelling ingredients, thickeners, adhesives, moisture retainers, stabilizers, film-forming and texturizing ingredients. In gluten-free products, starch is incorporated into the food formulation in order to improve one or more of these properties. This depends on the interaction with other ingredients in the formulation and on the type of food product (Miyazaki et al., 2002). Native or crude starch comes in the form of granules, the size, shape, and molecular arrangement of which depend on the plant species and genetic-environment interactions. Bread dough can be described as a bi-continuous network of proteins and starch (Eliasson et al., 1993); during the bread baking process, starch granules gelatinize, that is, they swell and are partly solubilized, but still retain their granular identity (Hug-Iten et al., 2001). Starch gelatinization plays an important role in gluten-free formulations, thanks to the formation of a matrix in which gas bubbles are trapped, which increases the gas retention capacity of the batters. In gluten-free formulations, starch improves the softness of the crumb, maintains the consistency of the batter during mixing, and gelatinizes during the baking process (Abdel-Aal et al., 2009); therefore, the addition of gelling starches such as pre-gelatinized starches and air cell stabilizers such as gums has been suggested as a means of providing gas occlusion as stabilizing agents.

The addition of vegetable fibers (such as corn bran, pea fiber, oat bran, sugar beet fiber, soybean fiber, rice bran, carob fiber, linseed fiber, apple fiber, psyllium husk fiber) in gluten-free products enriches them at a nutritional level and assists their structure; moreover, it significantly influences their color, firmness, moisture, staleness and microstructural characteristics (Arslan et al., 2019), therefore the added amount of this fiber in relation to the other ingredients can play a considerable role.

In baked products it is known that thickeners (generally branched polysaccharides with high molecular weight) can be used to improve the performance of doughs and the characteristics and structural and sensory quality of such products, as well as to prolong their shelf life. Water-soluble gums are also known as “hydrocolloids” and are used as dietary fibers, structure enhancers, thickeners, gelling agents, stabilizers, emulsifiers, and glazing agents. They are found in various plant, microbial and animal sources and their use in bread making and confectionary is linked to their ability to control the rheology and structure of aqueous suspensions (Salehi, 2019). Various hydrocolloids can improve the quality of fresh wheat bread (therefore in the presence of gluten), as well as its aging, already in concentrations of 0.1% by weight with respect to the flour (Guarda et al., 2004): different effects for different hydrocolloids have been observed on the specific volume index, width/height ratio and hardness of the crumb, reduction of the rate of dehydration of the crumb during preservation of the bread and delay in the hardening of the crumb during storage. Furthermore, the addition of gums increases the volume and porosity of gluten cakes, leading to softer products (Salehi, 2017; Turabi, Sumnu and Sahin, 2010). Cake doughs are complex mixtures of flour and various ingredients, in which liquids play an essential role in creating a network that connects the various powdered or dry ingredients, possibly hydrating them. The properties of such systems are further altered by the addition of hydrocolloids (Kaur et al., 2015). The influence of hydrocolloids on the final volume of the cake is due to the increase in the viscosity of the cake dough (Gomez, Ronda, Caballero, Blanco, & Rosell, 2007), which slows down the rate of gas diffusion and allows it to be retained during the early baking stages (Salehi & Kashaninejad, 2018). Therefore, various gluten-free formulations (composite and wheat-free flours) contain gums to mimic the viscoelastic properties of gluten, and the comparison between bread and cakes prepared with gluten-free flour alone and those with the addition of gums has revealed that the incorporation of gum leads to a significant improvement in texture, volume, color, appearance, flavor and overall acceptability (Salehi, 2019). However, the alveolation remains hardly comparable to the alveolation present in a product with gluten.

In recent years, in the conventional sector with gluten, continuous dosing technologies have appeared, which can be advantageously combined with continuous processing to produce leavened food products, and in particular with continuous leavening, which have contributed to the improvement of conventional products and production processes. This approach, which leads to increased efficiency, has thus far instead been precluded from gluten-free products, for which the continuous leavening of a sheet of dough has not yet been implemented industrially, due to the fragility and stickiness of gluten-free doughs. In fact, gluten-free doughs, since they do not have a gluten mesh, do not exhibit viscoelastic behaviors and do not withstand the significant mechanical stresses of the continuous leavening step, caused by the passage of the dough sheet on consecutive conveyor belts during this step. In particular, continuous leavening devices provide conveyor belts one on top of the other, connected through rollers, as described in U.S. Pat. No. 4,362,751, and the critical part for the hold of the dough sheet is the passage from one conveyor belt to another.

The document “Gluten-Free Brioche Loaf” GNPD DATABASE [Online]; MINTEL, Database accession no. 8673273, describes a formulation for leavened and gluten-free brioche bread.

The document “Gluten-Free Panettone” GNPD DATABASE [Online]; MINTEL, Database accession no. 10382192, describes a formulation for gluten-free panettone.

The document Gluten Free Stories: “Buttery Gluten-Free Brioche Bread” https://www.glutenfreestories.com/gluten-free-brioche-bread/ describes a formulation for leavened and gluten-free brioche bread in which a gluten-free dough is prepared that is rolled to form a loaf that is divided into four equal portions. These portions are worked until eight smooth balls of dough are created, which are positioned on a baking sheet to leaven and are then oven baked.

The document Barbone Elizabeth: “Gluten-Free Tuesday: Panettone Recipe” https://www.seriouseats.com/gluten-free-tuesday-panettone-christmas-bread describes another formulation for gluten-free panettone.

There is therefore the need to perfect a formulation, a rolled dough and a method for producing a naturally leavened and gluten-free food product that can overcome at least one of the disadvantages of the state of the art.

To do this it is necessary to solve the technical problem of providing formulations and rolled doughs for producing naturally leavened and gluten-free baked food products, and with a method suitable for industrial production which provides that at least the leavening of the sheet of rolled dough is carried out continuously, in particular in order to obtain workable, non-sticky doughs that can be processed on a continuous rolling line suitable for leavened desserts.

In particular, one purpose of the present invention is to provide a naturally leavened and gluten-free baked food product having an alveolar structure that is similar to that of breads containing gluten.

Another purpose of the present invention is to provide a formulation, a rolled dough, and develop a method for producing a naturally leavened and gluten-free baked food product having an alveolar structure that is similar to that of breads containing gluten.

Another purpose of the present invention is to provide a method for the industrial production of a naturally leavened and gluten-free baked food product which provides that at least some production steps that follow kneading, and in particular the leavening of the sheet of dough, are carried out continuously.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, some embodiments described here concern a formulation and a rolled dough for producing a naturally leavened and gluten-free baked food product, wherein the formulation, and also the rolled dough, is essentially without gluten.

In some embodiments, in the formulation and in the rolled dough there is a mixture of powdered or dry ingredients, a mixture of liquid ingredients and natural yeasts, wherein a weight/weight ratio between dry ingredients and liquid ingredients is in a range from 1.0 to 2.5.

In some embodiments, moreover, the mixture of powdered ingredients comprises flour and starch and fibers which are in addition to the starch and fibers present in the flour and optionally thickeners, and the mixture of liquid ingredients comprises water, liquids source at least of proteins, in particular milk, eggs and/or derivatives thereof and any sweetening syrups.

The formulation described here is used to produce the rolled dough as above.

The specific formulation of the rolled dough according to the present description can be worked in plants continuously because it is not sticky, unlike known gluten-free formulations.

The Applicant has found that the proportion between powdered ingredients and liquid ingredients allows to obtain a workable dough, in particular thanks to the fact that the liquids contain proteins useful for structuring the dough during cooking. Furthermore, starches and fibers present in the dough formulation also play an important role in achieving this result.

In some embodiments, the starch and flour do not derive from cereals containing gluten, in particular wheat, spelt, barley, rye, triticale.

Favorably, a weight/weight ratio between the sum of additional starch and flour and the sum of additional fibers and optional thickeners is between 0.06 and 0.12, in particular between 0.07 and 0.11, more in particular between 0.08 and 0.1. The Applicant has found that this ratio is particularly advantageous for obtaining a workable dough, which is not sticky and allows to obtain the naturally leavened and gluten-free food product described here.

Other embodiments described here concern a method for producing a naturally leavened and gluten-free baked food product, the method comprising obtaining a rolled dough from powdered or dry ingredients, liquid ingredients and natural yeasts, making the dough leaven and subjecting the leavened dough to oven baking.

In some embodiments, the method comprises:
making available a first portion of mixture of powdered or dry ingredients, mixture of liquid ingredients and natural yeasts;
subjecting the first portion to a first natural leavening;
adding to the first portion subjected to natural leavening a second portion of mixture of powdered or dry ingredients, mixture of liquid ingredients and additional natural yeasts, mixing the first portion with the second portion obtaining a dough;
cooling the dough;
rolling the dough, in particular to obtain a sheet of rolled dough;
subjecting the rolled dough to a second natural leavening;
subjecting the leavened dough to oven baking.

Favorably, in some embodiments the sheet of dough obtained from rolling is continuously subjected to the second natural leavening, that is, while the sheet of dough obtained from the rolling is made to advance. In some embodiments, therefore, the steps of the method described here that are carried out after the mixture is obtained are advantageously carried out continuously, that is, while the sheet of dough is made to advance.

In some embodiments, rolling the dough can be carried out continuously.

In some embodiments, subjecting the leavened dough to oven baking can be carried out continuously.

In some embodiments, a weight/weight ratio between the first portion and the dough is equal to or greater than 0.1, in particular it is from 0.1 to 0.3, more in particular from 0.1 to 0.2.

In some embodiments, the powdered ingredients comprise flour and starch and fibers which are in addition to the starch and fibers present in the flour and optionally thickeners and the liquid ingredients comprise water and liquids source at least of proteins, in particular milk, eggs and/or derivatives thereof.

In some embodiments, the first natural leavening is carried out at a temperature of between 20° C. and 35° C., with a relative humidity of between 70% and 95% and for a time of between 45 minutes and 90 minutes.

In some embodiments, the cooling is carried out in order to cool the leavened dough to a temperature of between 10° C. and 16° C. Advantageously, this cooling is useful and suitable to make the consistency of the dough suitable for rolling.

In some embodiments, the cooled dough is rolled to a thickness of between 7 mm and 15 mm.

In some embodiments, the second natural leavening is carried out at a temperature of between 20° C. and 35° C., with a relative humidity of between 70% and 95% and for a time of between 1 hr and 2 hrs.

In some embodiments, the oven baking is carried out for a time of between 20 minutes and 30 minutes, wherein the baking is obtained by means of a temperature of between 150° C. and 180° C. of an upper part of the oven and a temperature of between 160° C. and 200° C. of a lower part of the oven.

In some embodiments, after the baking, there is provided a cooling of the baked product and a cutting of the product into the desired format, there being optionally provided an internal filling of the product after the cooling.

Possibly, for example before baking, an upper garnishing of the product can also be carried out.

In some embodiments, there is provided a naturally leavened and gluten-free baked food product which can be obtained by means of the formulation and the rolled dough described here.

In other embodiments, there is provided a naturally leavened and gluten-free baked food product which can be obtained by means of the method described here.

In some embodiments, the baked food product described here can be of the sponge cake-based type, in particular with a non-homogeneous alveolate structure for example.

In some embodiments, the baked food product described here can be in the shape of an elongated parallelepiped, a slice or small slice.

In some embodiments, the baked food product described here can be in the form of a naturally leavened and gluten-free sweet food product, in particular a sweet snack.

The food product described here can favorably be produced continuously and it can favorably be formulated in order to be produced industrially and continuously.

In some embodiments, the naturally leavened and gluten-free baked food product can be, for example, a sweet gluten-free bread-based product, even more in particular a so-called naturally leavened and gluten-free sweet snack, whether filled, for example with cream, marmalade or fruit jam or similar fruit-based composition, or not filled.

Other embodiments described here concern a plant for producing a naturally leavened and gluten-free food product, by means of a dough consisting of powdered or dry ingredients, liquid ingredients and natural yeasts which is made to leaven and subjected to oven baking, wherein the plant comprises:
a kneader to obtain a first portion of mixture of powdered or dry ingredients, mixture of liquid ingredients and natural yeasts;
a first leavener in which to subject the first portion to a first natural leavening;
a kneader in which to add, to the first portion subjected to natural leavening, a second portion of mixture of powdered or dry ingredients, mixture of liquid ingredients and other natural yeasts, mixing the first portion with the second portion obtaining a dough. This kneader can be the same kneader in which the first portion of mixture of ingredients as above is obtained, or a dedicated kneader;
means for cooling the dough;
a device for rolling the dough, in particular to obtain a sheet of dough;
a second continuous leavener in which to subject the sheet of dough to a second continuous natural leavening;
an oven for subjecting the leavened dough to baking.

In some embodiments, the first leavener is configured to carry out a natural leavening at a temperature of between 20° C. and 35° C., with a relative humidity of between 70% and 95% and for a time of between 45 minutes and 90 minutes.

In some embodiments, the cooling means are configured to carry out a cooling of the leavened dough to a temperature of between 10° C. and 16° C.

In some embodiments, the rolling device is configured to carry out a rolling of the cooled dough to a thickness of between 7 mm and 15 mm.

In some embodiments, the second leavener is configured to carry out a natural leavening at a temperature of between 20° C. and 35° C., with a relative humidity of between 70% and 95% and for a time of between 1 hr and 2 hrs.

In some embodiments, the oven is configured to carry out a baking for a time of between 20 minutes and 30 minutes, in particular being configured so that an upper part of the oven carries out the baking at a temperature of between 150° C. and 180° C., and a lower part of the oven carries out the baking at a temperature of between 160° C. and 200° C.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic representation of a plant that can, for example, be used to carry out a method according to the embodiments described here;

FIG. 1a is a detail of a part of the plant of FIG. 1.

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

We will now refer in detail to the possible embodiments of the invention. The phraseology and terminology used here is for the purposes of providing non-limiting examples.

The embodiments described here concern formulations, leavened doughs, methods and plants for producing naturally leavened and gluten-free baked food products and, in addition, naturally leavened and gluten-free baked food products thus obtained.

Please note that by the term “gluten-free” we mean food products whose gluten content is lower than 20 ppm (parts per million).

Some embodiments described here concern, in particular, a formulation and a rolled dough for producing a gluten-free baked food product.

The peculiar structure of the baked food product that can be obtained by means of the formulation as above and the corresponding rolled dough is made possible by the proportions between a mixture of powdered or dry ingredients and a mixture of liquid ingredients, containing water, present in said formulation.

According to possible embodiments, the weight/weight ratio between dry ingredients and liquid ingredients in the formulation and in the corresponding rolled dough can vary between 1.0 and 2.5, and is preferably 1.18. This range, for example this specific proportion, is advantageous to obtain the peculiar aerated and extensible structure of the finished food product after cooking.

According to possible embodiments, a weight/weight ratio between the sum of additional starch and flour with respect to the sum of additional fibers and optional thickeners is between 0.06 and 0.12, in particular between 0.07 and 0.11, more in particular between 0.08 and 0.1, more in particular between 0.085 and 0.095. Possible examples are: 0.06, 0.065, 0.07, 0.075, 0.08, 0.085, 0.09, 0.095, 0.1, 0.105, 0.11, 0.115, 0.12. These examples can in turn be combined to obtain other sub-ranges of this ratio, which can be used in the embodiments described here, such as for example between 0.06 and 0.11, between 0.06 and 0.1, between 0.06 and 0.09, between 0.07 and 0.12, between 0.07 and 0.1, between 0.08 and 0.12, between 0.08 and 0.11, between 0.08 and 0.1, between 0.06 and 0.1, between 0.07 and 0.12, between 0.09 and 0.12, or others.

The Applicant has found that this weight/weight ratio between the sum of additional starch and flour with respect to the sum of additional fibers and optional thickeners is particularly advantageous to obtain a workable dough, which is not sticky and allows to obtain the naturally leavened and gluten-free food product described here.

The presence of fibers in the dough and in the respective formulation also allows to create a gel that will support, in the final dough, the deficiencies of an absent gluten mesh.

According to possible embodiments, a weight/weight ratio between the first portion and the final dough is equal to or greater than 0.1, in particular it is in a range from 0.1 to 0.3, more in particular from 0.1 to 0.2. In other words, more than 10%, in particular from 10% to 30%, more in particular from 10% to 20% by weight of the formulation of the final dough can be supplied as a pre-dough that is added to a subsequent mixture of ingredients in order to obtain the final dough which, once naturally leavened, is baked in the oven. An example is a percentage of at least 15%.

According to possible embodiments, the mixture of dry ingredients comprises starches, flours, fibers and optionally thickeners, and the mixture of liquid ingredients comprises water, liquids source at least of proteins, such as for example milk and eggs and/or derivatives.

According to possible preferred embodiments, the additional flours and starches comprised among the dry ingredients can be rice flour, cornstarch and rice starch.

According to possible preferred embodiments, the fibers comprised among the dry ingredients can be soluble fibers, for example psyllium husk fiber, and cellulose-based insoluble fiber.

According to possible preferred embodiments, the mixture of liquid ingredients comprises, or consists of, water, milk, eggs and derivatives.

According to possible preferred embodiments, the protein content of the formulation and rolled dough according to the present invention is between 2% and 6% by weight with respect to the weight of the formulation and rolled dough, for example 2.7%. In possible implementations, the protein content of the formulation and of the rolled dough according to the present invention is represented by milk caseins, albumins and globulins.

Other embodiments concern a method for producing a naturally leavened and gluten-free baked food product, in particular a product based on sweet gluten-free bread, even more in particular a so-called naturally leavened and gluten-free sweet snack, whether filled, for example, with cream, marmalade or fruit jam or similar fruit-based composition, or not filled.

In some embodiments, the method comprises:
making available a first portion, or pre-dough, of mixture of powdered or dry ingredients, mixture of liquid ingredients and natural yeasts, for example brewer's yeasts;
subjecting the first portion to a first natural leavening;
adding to the first portion subjected to natural leavening a second portion of mixture of powdered or dry ingredients, mixture of liquid ingredients and additional natural yeasts, brewer's yeasts for example, mixing the first portion with the second portion to obtain a dough, or complete dough;
cooling the dough;
rolling the dough;
subjecting the rolled dough to a second natural leavening;
subjecting the leavened dough to oven baking.

In particular, some embodiments of the method provide preparing the pre-dough, or biga, which is pre-fermented (first leavening), preparing the complete dough, which is leavened in the second leavening step, cooking and possibly finishing the food product. According to one possible embodiment, the step of preparing the first portion, or pre-dough, can comprise a first kneading step P1, in which a desired aliquot of the dry and liquid ingredients provided by the pre-dough formulation are kneaded together. In particular, the pre-dough contains an adequate quantity of yeasts, in so-called latency phase, in which the microorganisms that constitute them do not bring volume changes to the pre-dough.

Subsequently, in a first leavening step P2, the pre-dough is leavened. In this step, the yeasts of the pre-dough pass the latency phase and cause an increase in volume of the pre-dough. Preferably, the leavening occurs in an environment with controlled temperature and humidity.

According to possible embodiments, the leavening of the pre-dough takes place for a time of between 45 minutes and 90 minutes, for example 45 minutes.

According to possible embodiments, the leavening of the pre-dough takes place at a temperature of between 20° C. and 35° C., for example at 30° C.

According to possible embodiments, the leavening of the pre-dough takes place with a relative humidity of between 70% and 95%, for example 85%.

Then follows the preparation of the complete dough, in which, in a second kneading step I1, the dry and liquid ingredients provided by the dough formulation, including the leavened pre-dough, are kneaded together. As mentioned above in percentage terms, the weight/weight ratio between the first portion, or pre-dough, and the dough, or complete dough, is equal to or greater than 0.1, in particular it is in a range from 0.1 to 0.3, in particular from 0.1 to 0.2, for example 0.15.

Advantageously, the use of the pre-dough allows to have two populations of yeasts in the complete dough: the first, brought by the pre-dough, has passed the latency phase; the other is added in the second kneading step I1. This allows to have an alveolate structure with more irregular cells, which moves away from the alveolate structure of typical sponge cake and is closer to conventional bread.

Then, in a first cooling step I2, the complete dough is subjected to cooling, for example inside the respective kneader. This is possible, for example, if the kneader is provided with a cooling jacket or equivalent cooling means, and in this case the dough can be subjected to cooling also during the mixing.

According to possible embodiments, in the first cooling step I2 the complete dough is cooled to a temperature of between 10° C. and 16° C., for example 13° C.

According to possible embodiments, the cooling of the complete dough takes place for a period of time of between 15 minutes and 40 minutes, for example for 22 minutes.

Advantageously, the first cooling step I2 blocks both the aforementioned yeast populations contained in the complete dough, preventing the dough from leavening before a dedicated second leavening step described below.

Furthermore, advantageously, the first cooling step I2 makes the complete dough suitable for a rolling step I3, subsequent to the first cooling step I2. In fact, the cooling makes the dough less fluid, and it is therefore possible to roll it, that is, spread it out in a layer, or sheet, of a desired thickness.

In the rolling step I3, the dough is spread to form a continuous sheet of dough, of a desired thickness.

According to possible embodiments, the rolling can be carried out continuously.

According to possible embodiments, the thickness of the rolled dough is between 7 mm and 15 mm, in particular between 9 mm and 10 mm.

We wish to clarify that the Applicant has found it advantageous for the gluten-free rolled doughs to have a thickness greater than the typical thicknesses of their gluten-containing counterparts, since the gluten-free doughs are not able to withstand volume increases as high as those normally obtained for gluten-containing doughs.

In particular, some dough embodiments described here, after leavening, grow to 75% of the final height and no more.

The dough sheet is obtained continuously thanks to the rolling and is fed continuously to the following second natural leavening step, as described below.

In particular, subsequently, in a second natural leavening step I4, the rolled dough, that is, the dough sheet produced continuously by the rolling, is made to leaven. Favorably, the dough sheet obtained from the rolling is continuously subjected to the second leavening step I4.

Preferably, the second leavening step occurs in an environment with controlled temperature and humidity.

According to possible embodiments, the leavening of the rolled dough takes place for a period of time between 1 hr and 2 hr, for example 1 h.

According to possible embodiments, the leavening of the rolled dough takes place at a temperature of between 20° C. and 35° C., for example at 31° C.

According to possible embodiments, the leavening of the rolled dough takes place with a relative humidity of between 70% and 95%, for example 85%.

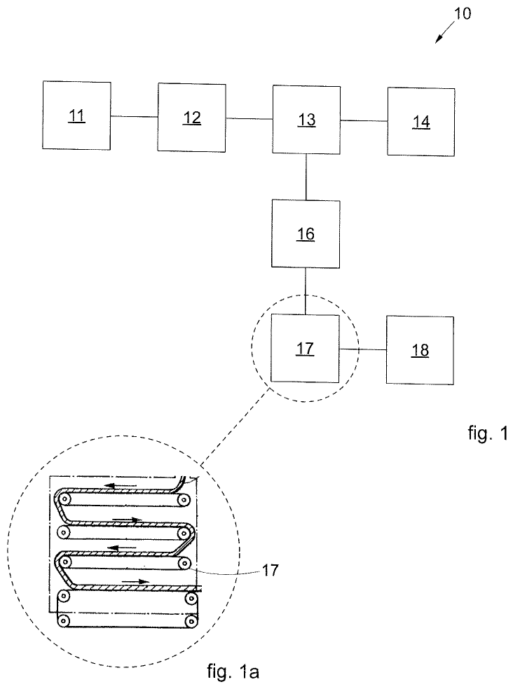

In some embodiments, the leavening of the rolled dough takes place continuously, that is, during the translation of the continuous sheet of rolled dough, for example on a plurality of conveyor belts disposed one below the other and connected by rollers (FIG. 1a), so that, in the passage from one given conveyor belt to the next, a lower surface of the dough sheet, in contact with the given conveyor belt, is exposed upward on the next conveyor belt, and conversely an upper surface of the dough sheet, exposed upward and opposed to the given conveyor belt, comes into contact with the next conveyor belt.

This type of continuous leavening of the dough sheet is usually used for doughs containing gluten in order to obtain an extremely uniform leavening for the entire thickness of the dough sheet, but to date it had not been realized for gluten-free doughs, generally unable to withstand the considerable mechanical stresses that they would be subjected to in the passage from one conveyor belt to another.

Advantageously, the Applicant has found that the method and the formulation and the rolled dough according to the embodiments described here instead make it possible to carry out the second leavening step I4 continuously, as described above.

Advantageously, the Applicant has also found that the use of the first portion, or pre-dough, or biga, favorably yields an alveolate that is similar to bread and represents an advantageous compromise with respect to the leavening times that are reduced compared to the traditional production of leavened products with gluten. In fact, the Applicant has found the need to use a shorter overall leavening time of the gluten-free products in question, because leavening the product too much would risk it collapsing, since the contribution of the gluten mesh is essentially missing. For this reason, the Applicant has found that a favorable compromise to obtain the desired alveolar structure is to use the first portion, or pre-dough, or biga, which is pre-fermented as explained above.

The Applicant has found that the rolling step, preferably continuous, to which the dough described here is subjected also promotes the fermentative activity of the yeasts, contributing to a better volumetric development and a more active fermentation. Rolling therefore plays a role in strengthening the structure of the dough, which is especially advantageous since the formulation used for the dough described here is gluten-free. The Applicant has found that a non-rolled dough slowly decreases fermentation, because the yeast cells cannot move actively throughout the entire mass, precisely because the dough is hard, as a result they consume the sugars of the same zone, which are depleted of nutrients. In the end, this process leads to the accumulation of toxic products that act as inhibitors for the cells of the yeast themselves. Instead, with the rolling to which the dough described here is subjected, the dough mass itself is remixed and the zones around the yeast cells are renewed, allowing the cells to feed and the toxic products to be eliminated. Fermentation is more active, and the volume is more developed. In this way, in addition to the formulation of the dough, the rolling to which the latter is subjected also reinforces the consistency and resistance of the dough itself, making it workable and non-sticky.

Subsequently, in the cooking step, the leavened dough sheet is oven baked.

In preferred embodiments, the oven has a sky temperature thereof (upper part of the oven) lower than a base temperature thereof (lower part of the oven).

According to possible embodiments, the sky temperature of the oven is between 150° C. and 180° C., for example 160° C.

According to possible embodiments, the base temperature of the oven is between 160° C. and 200° C., for example 170° C.

According to possible embodiments, the cooking takes place for a period of time of between 20 minutes and 30 minutes, for example 23 minutes.

According to possible embodiments, the cooking can be carried out continuously.

Subsequently, in a step of finishing the food product, the sheet of baked bread is cooled in a second cooling step F1. The step of finishing the food product can also comprise steps of cutting the baked bread sheet into the desired format (for example elongated parallelepiped, slice, small slice or suchlike), and/or steps of internally filling the food product and/or other steps, depending on the shape and characteristics desired for the finished food product. The steps of internally filling the food product are preferably carried out after the cooked product has been cooled and can be performed before or after cutting to format.

Possibly, for example before cooking, steps of garnishing and/or upper decoration of the food product can also be carried out.

According to some embodiments, the gluten-free baked food product which can be obtained from the formulation and the rolled dough, and by means of the method which are described above has a water activity (a_{w}) of between 0.7 and 0.9, for example 0.85.

According to some embodiments, the gluten-free baked food product described here has a humidity comprised between 20% and 40%.

An example of a gluten-free baked food product according to the embodiments described here is a filled, continuously leavened sweet bread. For example, the sweet bread can be filled with milk cream, or chocolate cream, or fruit jam, or other filling.

Other embodiments, described using FIG. 1, concern a plant 10 for producing a gluten-free baked food product. The plant 10 can be used to produce the food product in question in accordance with a production method according to the embodiments described.

According to possible embodiments, the plant 10 comprises a first kneading device 11, or first kneader, for example a planetary motion kneading device, configured to carry out the first step P1 of kneading the pre-dough.

Furthermore, the plant 10 comprises a first leavening device, or first leavener, 12, configured to carry out the first step P2 of leavening the pre-dough. This first leavening device 12 can be of a discontinuous or batch type, for example a leavening tank, or of a continuous type.

The second step I1 of kneading the complete dough can be carried out in the first kneading device 11. Alternatively, the plant 10 can comprise a second kneading device 13, or second kneader, for example a planetary motion kneading device, dedicated to carrying out the second kneading step I1. This alternative can be combined with the variant in which the first step P2 of leavening the pre-dough is carried out continuously.

The plant 10 is also provided with cooling means 14, preferably associated with the second kneading device 13, which are configured to carry out the first cooling step I2, and with a rolling device 16, for example having rolling rolls, which is configured to carry out the rolling step I3 to obtain the sheet with the desired thickness.

The plant 10 also comprises a second leavening device, or second leavener, 17 (FIGS. 1 and 1a), configured to carry out the second leavening step I4 continuously, that is, to carry out the leavening of the sheet.

The plant 10 is also provided with an oven 18, configured to carry out the cooking step. For example, the oven 18 can be a tunnel oven.

According to possible embodiments, the plant 10 also comprises apparatuses or means configured to carry out possible steps of finishing the food product, in particular one or more of either cooling, filling, garnishing or other decoration or cutting to format.

It is clear that modifications and/or additions of parts or steps may be made to the method, to the formulation, to the rolled dough and to the food product and plant 10 as described heretofore, without departing from the field and scope of the present invention, as defined by the claims. It is also clear that, although the present invention has been described with reference to some specific examples, a person of skill in the art will be able to achieve other equivalent forms of formulation, rolled dough, method and plant, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. Rolled dough for producing a naturally leavened and gluten-free baked food product, wherein said rolled dough is essentially without gluten and wherein in said rolled dough there is a mixture of powdered or dry ingredients, a mixture of liquid ingredients and natural yeasts, wherein a weight/weight ratio between dry ingredients and liquid ingredients is in a range from 1.0 to 2.5 and wherein said mixture of powdered ingredients comprises flour and starch and fibers which are in addition to the starch and fibers present in said flour and optionally thickeners, and said mixture of liquid ingredients comprises water, liquids source at least of proteins, in particular milk, eggs and/or derivatives thereof and any sweetening syrups.

2. Rolled dough as in claim 1, wherein said starch and flour do not derive from cereals containing gluten, in particular wheat, spelt, barley, rye, triticale.

3. Rolled dough as in claim 1, wherein said rolled dough has a thickness from 7 mm to 15 mm.

4. Rolled dough as in claim 1, wherein a weight/weight ratio between the sum of additional starch and flour and the sum of additional fibers and optional thickeners is between 0.06 and 0.12, in particular between 0.07 and 0.11, more in particular between 0.08 and 0.1.

5. Method for producing a naturally leavened and gluten-free baked food product, said method comprising:
making available a first portion of mixture of powdered or dry ingredients, mixture of liquid ingredients and natural yeasts;
subjecting said first portion to a first natural leavening;
adding to said first portion subjected to natural leavening a second portion of mixture of powdered or dry ingredients, mixture of liquid ingredients and additional natural yeasts, mixing said first portion with said second portion obtaining a dough;
cooling said dough;
rolling said dough obtaining a rolled dough;
subjecting said rolled dough to a second natural leavening which is carried out continuously while a sheet of rolled dough obtained from said rolling is made to advance;
subjecting said leavened dough to oven baking, wherein a weight/weight ratio between said first portion and said dough is equal to or greater than 0.1, in particular it is from 0.1 to 0.3, more in particular from 0.1 to 0.2.

6. Method as in claim 5, wherein said powdered ingredients comprise flour and starch and fibers which are in addition to the starch and fibers present in said flour and optionally thickeners and said liquid ingredients comprise water and liquids source at least of proteins, in particular milk, eggs and/or derivatives thereof.

7. Method as in claim 5, wherein said first natural leavening is carried out at a temperature of between 20° C. and 35° C., with a relative humidity of between 70% and 95% and for a time of between 45 minutes and 90 minutes.

8. Method as in claim 5, wherein said cooling is carried out in order to cool said leavened dough to a temperature of between 10° C. and 16° C.

9. Method as in claim 5, wherein said cooled dough is rolled to a thickness of between 7 mm and 15 mm.

10. Method as in claim 5, wherein said second natural leavening is carried out at a temperature of between 20° C. and 35° C., with a relative humidity of between 70% and 95% and for a time of between 1 hr and 2 hrs.

11. Method as in claim 5, wherein said oven baking is carried out for a time of between 20 minutes and 30 minutes, wherein said baking is obtained by means of a temperature of between 150° C. and 180° C. of an upper part of the oven and a temperature of between 160° C. and 200° C. of a lower part of the oven.

12. Method as in claim 5, wherein, after said baking, there is provided a cooling of the baked product and a cutting of the product into the desired format, there being optionally provided an internal filling and/or an upper garnishing of the product after the cooling.

13. Method as in claim 5, wherein rolling said dough is carried out continuously.

14. Method as in claim 5, wherein subjecting said leavened dough to oven baking is carried out continuously.

15. Naturally leavened and gluten-free baked food product obtained by means of a rolled dough as in claim 1.

16. Baked food product as in claim 15 of the sponge cake-based type, in particular with a non-homogeneous alveolate structure.

17. Baked food product as in claim 15, in the shape of an elongated parallelepiped, slice or small slice.

18. Baked food product as in claim 15, in the form of a naturally leavened and gluten-free sweet food product, in particular sweet snack.
